(19) United States
(12) Patent Application Publication
(10) Pub. No.: US 2011/0132860 A1
(43) Pub. Date: Jun. 9, 2011

(54) DERRICK CRANE

(75) Inventors: Roland Bohnacker, Blaubeuren (DE); Gerold Kranke, Ehingen (DE)

(73) Assignee: Liebherr-Werk Ehingen GmbH, Ehingen/Donau (DE)

(21) Appl. No.: 12/793,120

(22) Filed: Jun. 3, 2010

(30) Foreign Application Priority Data
Jun. 3, 2009 (DE) UM202009007785.3

(51) Int. Cl. B66C 23/82

(52) U.S. Cl. 212/262

(57) ABSTRACT

The present invention relates to a derrick crane having a main boom and a derrick boom whose tips are connected to one another via a main guying, with the main guying having a luffing rope arrangement of changeable length arranged between the main boom and the derrick boom to change the length of the main guying on the luffing up of the main boom and with at least two additional guying systems being provided which connect the main guying to the main boom, with the at least two additional g having a fixed length.

The present invention relates to a derrick crane having a main boom and a derrick boom whose tips are connected to one another via a main guying having a length-changeable luffing rope arrangement arranged between the main boom and the derrick boom to change the length of the main guying on the luffing up of the main boom.

On the luffing up of the main boom of a derrick crane, the derrick boom remains in a fixed position while the length of the main guying between the main boom and the derrick boom is changed via the Puffing rope arrangement. The geometry of the triangle comprising the main boom, the derrick boom and the main guying hereby changes constantly on the luffing up of the main boom.

On the raising and putting down of the main boom from an assembly position into a hoisting position, a tensioning force is introduced by the Puffing rope arrangement into the main guying (as a rule tie rods) fastened to the outer end of the main boom. The main guying thus pressurizes the boom by means of a first component, while the main boom is raised against its weight via a second component of this force. In this respect, the first component is always considerably larger than the second component due to the unfavorable angle relationships. In addition, the boom's own weight becomes larger as the length of the main boom increases. A high bending moment therefore acts on the main boom on the raising.

To reduce this bending moment, it is known to provide an additional guying between the main boom and the main guying which stabilizes the main boom on the raising and thus reduces the bending moments acting on the main boom. Particularly long booms can, however, no longer be raised as described above with only one additional guying. The solution is known to raise these particularly long booms to support the main boom with an additional guying of fixed length and a further additional guying of variable length. The additional guying located at the foot of the main boom in this respect has a variable length to be able to adapted to the changing geometrical relationships during the raising between the derrick boom, main boom and main guying. In this respect, in particular complicated rope guides are used having one or more pulley blocks for the additional guying systems. The rope length of the variable additional guying furthermore achieves substantial lengths (e.g. over 100 m), whereby the handling during the assembly is made more difficult.

For main booms which are raised in operation with SA-frame, a plurality of additional guying systems with fixed lengths and fixed connection points are admittedly already known. In this situation, however, the main boom, the guying block and the main guying form a triangle which is luffed up as a whole on the luffing up of the main boom, whereby the geometrical relationships in the triangle are approximately constant.

In derrick cranes having changing geometrical relationships during the luffing up, experts had, in contrast, previously assumed that when more than one additional guying was used, only additional guying systems having variable lengths were able to ensure a sufficient support of the main boom during the raising.

The inventors of the present invention have found, contrary to this prejudice of the experts, that surprisingly a plurality of additional guying systems of fixed lengths are suitable to support the main boom of a derrick crane sufficiently on the raising so that longer booms are also possible without the previously used variable additional guying systems. These longer booms can nevertheless be raised without an auxiliary crane.

The present invention thus comprises a derrick crane having a main boom and a derrick boom whose tips are connected to one another via a main guying, with the main guying having a luffing rope arrangement of changeable length arranged between the main boom and the derrick boom to change the length of the main guying on the luffing up of the main boom and with at least two additional guying systems being provided which connect the main guying to the main boom, with the at least two additional guying systems having a fixed length.

Due to the changeable geometry and to the demands, which change in dependence on the main boom angle, on the tensioning force in the additional guying systems, additional guying systems changeable in length would admittedly be the ideal solution with respect to the support of the main boom. Such length-changeable additional guying systems are, however, technically complex and complicated in handling. The inventors of the present invention have recognized in this respect that the additional guying systems of fixed length ensure a sufficient stability of the main boom and are substantially simpler in technical structure and in handling than the previously only used length-changeable additional guying systems. The assembly of the additional guying systems of fixed length is in particular substantially simpler.

The present invention is advantageously used in derrick cranes with a lattice mast main boom to support it in particular on the raising from the horizontal and with large radii at least two points between the pivotal connection of the boom and the boom tip.

In this respect, at least two additional guying systems of fixed length are provided since particularly long booms having only one additional guying can no longer be raised at all as described above. The at least two additional guying systems of fixed length in accordance with the invention thus represent a solution which achieves a sufficient stability with minimum effort and minimum additional weight.

Further advantageously, the additional guying systems are connected at fixed connection points to the main guying and the main boom. The geometry of the main guying and of the additional guying is therefore only defined via the fixed positions of the connection points at the main guying and at the main boom and via the fixed lengths of the additional guying systems between these connection points. A particularly simple assembly and an extremely small additional weight for the guying hereby in turn result. Each additional guying in this respect extends from a connection point to the main guying to the connection point to the additional guying.

In accordance with the invention, the length of the at least two additional guying systems and the position of the connection points are advantageously selected so that both additional guying systems transfer a tensioning force onto the main boom at the start of the raising procedure of the main boom. Both additional guying systems hereby receive a force supporting the main boom on the raising of the main boom. The length and arrangement of the additional guying systems is selected in this respect so that the forces introduced from the additional guying systems into the main boom during the crane operation in the raised state increase the lifting capacity of the crane or at least only impair it a lithe.

Alternatively or additionally, however, provision can also be made that the length of the additional guying systems and the position of the connection points are selected so that at least one additional guying is not loaded at the start of the raising procedure of the main boom and only transfers a tensioning force to the main boom on the exceeding of a specific raising angle. The initially not loaded additional guying thus does not serve the raising of the main boom, but rather the increase in lifting capacity at specific, in particular shallow, boom angles. The initially not loaded additional guying can in this respect in particular be a third additional guying.

The additional guying systems are advantageously formed by ropes of fixed lengths. They are arranged between the fixed connection points at the main boom and at the main guying.

More than two additional guying systems can also advantageously be used, in particular three additional guying systems.

The present invention will now be presented in more detail with reference to embodiments and to drawings. There are shown:

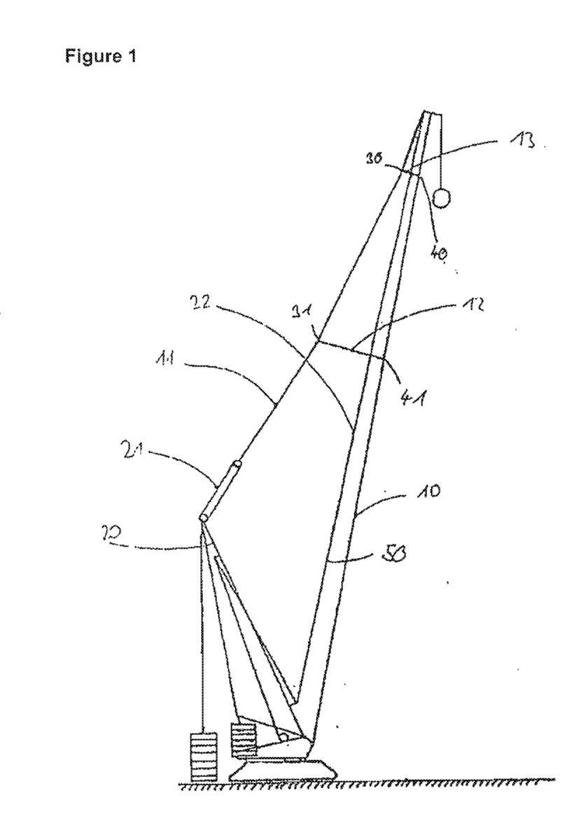

FIG. 1: a first embodiment of a derrick crane in accordance with the invention;

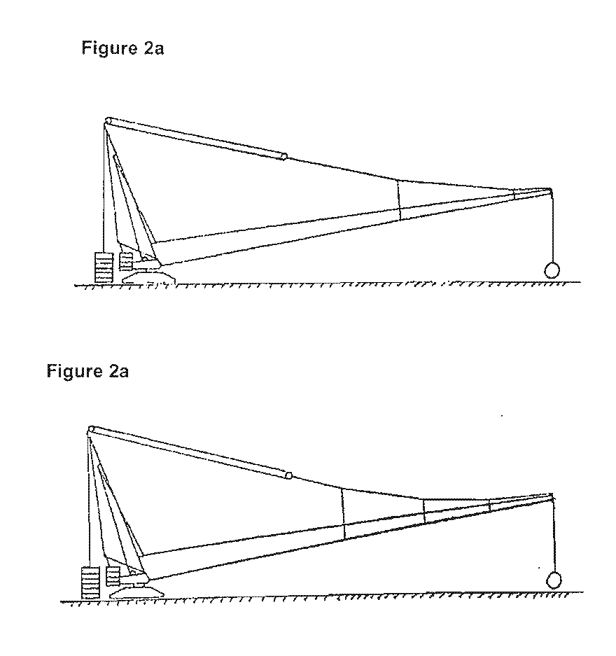

FIGS. 2a, 2b: two different embodiments of a derrick crane in accordance with the invention on the raising of the main boom; and

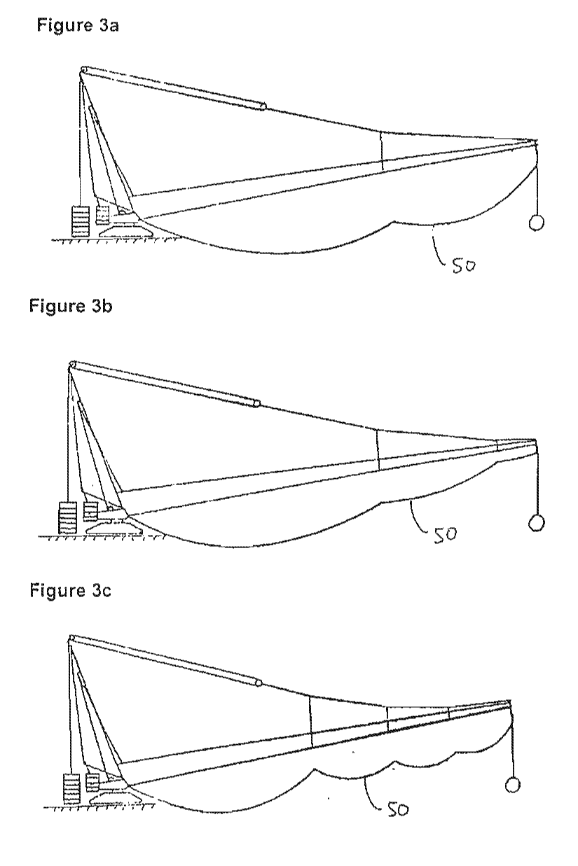

FIGS. 3a-3c: the bending moments in the main boom on raising in a derrick crane in accordance with the prior art in comparison with two derrick cranes in accordance with the present invention.

FIG. 1 shows an embodiment of a derrick crane in accordance with the invention having a main boom 10 and a derrick boom 20 whose tips are connected to one another via a main guying 11. The main boom 10 is in this respect only shown schematically as a line in the drawing. The main boom is advantageously a lattice mast boom. The derrick boom is equally advantageously a lattice mast boom. The main guying 11 has a length-changeable luffing rope arrangement 21 to change the length of the main guying for the luffing up of the main boom. The luffing rope arrangement 21 is in this respect integrated into the main guying between the main boom and the derrick boom and usually extends between the derrick boom and a deflection pulley of the main guying 11. The length of the luffing rope arrangement is in this respect changed via a winch. The derrick crane can furthermore have a derrick ballast which is arranged at the derrick boom. The derrick ballast can, however, also be separated from the crane after the raising of the boom. Furthermore, a hoist rope 50 is provided for the hoisting of the load and is guided via at least one deflection pulley at the tip of the main boom.

In addition to the main guying 11, two additional guying arrangements 12 and 13 which each have a fixed length are now provided in accordance with the invention. The additional guying systems 12 and 13 in this respect each extend between the main guying 11 and the main boom. The connection points 30 and 31 to the main guying 11 are in this respect each arranged at fixed positions between the main boom tip and the luffing rope arrangement, that is, the connection points are unchangeable in position with respect to the main guying 11. The connection points 40 and 41 to the main boom are each arranged at fixed positions between the main boom tip and the pivotal connection of the main boom to the superstructure, that is, the connection points are unchangeable in position to the main boom.

The two additional guying systems 12 and 13 are thus connected to the main guying 11 and to the main boom 10 at fixed connection points and each have a fixed length. The geometry of the guying is therefore solely defined by the position of the connection points and the fixed length of the additional guying systems. The fixedly defined lengths of the additional guying systems and the fixedly defined positions of the connection points are in this respect selected such that the additional guying systems can remain in engagement in every boom position and achieve a sufficient effect. This admittedly represents a disadvantage with respect to the guying properties in comparison with a solution having variable lengths of the additional guying systems such as are known from the prior art, but is surprisingly nevertheless suitable to provide a sufficient guying and is of advantage with respect to the saved costs, the saved weight and the saved number of components. The crane is in this respect advantageously made so that the additional guying systems can only be installed in a single defined position in the system comprising main boom 10 and main guying 11. The assembly of the additional guying systems is hereby further simplified.

In FIG. 2a, the embodiment shown in FIG. 1 is now shown on the raising of the main boom or with a main boom in a greatly luffed position. FIG. 2b, in contrast, shows a second embodiment of the present invention in which three additional guying systems of fixed lengths and fixed positions are used.

In FIGS. 3a to 3c, the bending moment development in the main boom with two derrick cranes in accordance with the present invention is compared schematically with a derrick crane in accordance with the prior art. The magnitude of the bending moment 50, which is shown schematically along the main boom, is in this respect represented by the spacing of the bending moment curve from the main boom.

In FIG. 3a, a derrick crane in accordance with the prior art is shown in this respect in which only one additional guying is provided. Particularly long booms can no longer be raised at all without external aids due to the high bending moments with only one such additional guying. In this respect, the problem is not the overturning, which could be solved by more ballast, but rather the destruction of the main boom. With only one additional guying, the tensions in the corner bars and in the corner bar connections are too high.

As shown in the FIGS. 3b and 3c, the bending moment in the main boom is reduced by the at least two additional guying systems provided in accordance with the invention so that considerably longer booms are made possible. In this respect, the inventors of the present invention have surprisingly found that, contrary to the prejudice of the experts, additional guying systems with fixed lengths can also be used for this purpose. The implementation of the fixed additional guying systems in this respect takes place so that they support the main boom sufficiently on raising and simultaneously only increase the lifting capacity in steep positions of the main boom or at only impair it a little.

Costs, weight and number of components can be saved by the present invention and the assembly can be considerably simplified.

1. A derrick crane having a main boom and a derrick boom whose tips are connected to one another via a main guying, with the main guying having a luffing rope arrangement of changeable length arranged between the main boom and the derrick boom to change the length of the main guying on the luffing up of the main boom and with at least two additional guying systems being provided which connect the main guying to the main boom, with the at least two additional guying systems having a fixed length.

2. A derrick crane in accordance with claim 1, wherein the additional guying systems are connected at fixed connection points to the main guying and to the main boom.

3. A derrick crane in accordance with claim 1, wherein the length of the at least two additional guying systems and the position of the connection points are selected so that both additional guying systems transfer a tensioning force to the main boom at the start of the raising process of the main boom.

4. A derrick crane in accordance with claim 1, wherein the length of the additional guying systems and the position of the connection points are selected so that at least one additional guying system is not loaded at the start of the raising process of the main boom and only transfers a tensioning force to the main boom on the exceeding of a specific luffing angle.

5. A derrick crane in accordance with claim 1, wherein the additional guying systems are formed by ropes of fixed lengths.

6. A derrick crane in accordance with claim 2, wherein the length of the at least two additional guying systems and the position of the connection points are selected so that both additional guying systems transfer a tensioning force to the main boom at the start of the raising process of the main boom.

7. A derrick crane in accordance with claim 2, wherein the length of the additional guying systems and the position of the connection points are selected so that at least one additional guying system is not loaded at the start of the raising process of the main boom and only transfers a tensioning force to the main boom on the exceeding of a specific luffing angle.

8. A derrick crane in accordance with claim 2, wherein the additional guying systems are formed by ropes of fixed lengths.

9. A derrick crane in accordance with claim 3, wherein the additional guying systems are formed by ropes of fixed lengths.

10. A derrick crane in accordance with claim 4, wherein the additional guying systems are formed by ropes of fixed lengths.

11. A derrick crane in accordance with claim 5, wherein the additional guying systems are formed by ropes of fixed lengths.

12. A derrick crane in accordance with claim 6, wherein the additional guying systems are formed by ropes of fixed lengths.

13. A derrick crane in accordance with claim 7, wherein the additional guying systems are formed by ropes of fixed lengths.
